(19) United States
(12) Patent Application Publication
(10) Pub. No.: US 2026/0281673 A1
(43) Pub. Date: Sep. 17, 2026

(54) SENSING MEASUREMENT SETUP METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/469,257

(22) PCT Filed: Mar. 31, 2023
(86) PCT No.: PCT/CN2023/085638

§ 371 Date: Sep. 25, 2025

(51) Int. Cl. H04W 4/38; H04W 88/08

(52) U.S. Cl. CPC H04W 4/38; H04W 88/08

(57) ABSTRACT

Embodiments of the present application relate to the technical field of mobile communications, and provide a sensing measurement setup method, an electronic device, and a storage medium. The sensing measurement setup method is applied to an access point (AP) device. The method includes: determining a measurement setup request frame, where the measurement setup request frame includes first identification information, and the first identification information indicates that the measurement setup requested by the measurement setup request frame is a sensing measurement process or a sensing by proxy (SBP) measurement process; and sending the measurement setup request frame.

### CROSS-REFERENCE TO RELATED APPLICATIONS

The present application is a U.S. National Stage of International Application No. PCT/CN2023/085638, filed on Mar. 31, 2023, the content of which is incorporated by reference herein in its entirety for all purposes.

### TECHNICAL FIELD

The embodiments of the present disclosure relate to the field of mobile communication technologies. Specifically, the embodiments of the present disclosure relate to a sensing measurement setup method, an electronic device, and a storage medium.

### BACKGROUND

Current Wi-Fi technologies under research may support wireless local area network (WLAN) sensing technology. For example, these technologies could be used for location discovery, proximity detection, and presence detection and so on in dense environments, such as homes and businesses. Currently, the WLAN sensing process needs to be further refined to meet wireless sensing requirements.

### SUMMARY

According to an aspect of the embodiments of the present disclosure, there is provided a method for sensing measurement setup, performed by an access point device (AP), including:
determining a measurement setup request frame; where the measurement setup request frame includes first identification information, and the first identification information indicates that a measurement setup requested by the measurement setup request frame is a sensing measurement process or a sensing by proxy SBP measurement process; and
sending the measurement setup request frame.

According to another aspect of the embodiments of the present disclosure, there is provided a method for sensing measurement setup, performed by a sensing responder, including:
receiving a measurement setup request frame; where the measurement setup request frame includes first identification information, and the first identification information indicates whether a measurement setup requested by the measurement setup request frame is a sensing measurement process or a sensing by proxy SBP measurement process.

According to another aspect of the embodiments of the present disclosure, there is provided a method for sensing measurement setup, performed by a sensing by proxy SBP initiator, including:
sending an SBP request frame to an AP, instructing the AP to determine and send a measurement setup request frame; where the measurement setup request frame includes first identification information, and the first identification information indicates that a measurement setup requested by the measurement setup request frame is a sensing measurement process or a sensing by proxy SBP measurement process.

According to another aspect of the embodiments of the present disclosure, there is provided an electronic device, serving as an access point device (AP), including:
a determining module, configured to determine a measurement setup request frame; where the measurement setup request frame includes first identification information, and the first identification information indicates that a measurement setup requested by the measurement setup request frame is a sensing measurement process or a sensing by proxy SBP measurement process; and
a first sending module, configured to send the measurement setup request frame.

According to another aspect of the embodiments of the present disclosure, there is provided an electronic device, serving as a sensing responder, including:
a receiving module, configured to receive a measurement setup request frame; where the measurement setup request frame includes first identification information, and the first identification information indicates that a measurement setup requested by the measurement setup request frame is a sensing measurement process or a sensing by proxy SBP measurement process.

According to another aspect of the embodiments of the present disclosure, there is provided an electronic device, serving as a sensing by proxy SBP initiator, including:
a second sending module configured to send an SBP request frame to an AP, instructing the AP to determine and send the measurement setup request frame; where the measurement setup request frame includes first identification information, and the first identification information indicates that a measurement setup requested by the measurement setup request frame is a sensing measurement process or a sensing by proxy SBP measurement process.

The embodiments of the present disclosure further provide an electronic device, including a memory, a processor, and a computer program stored in the memory and executable on the processor. When the processor executes the program, the method according to one or more of the embodiments of the present disclosure is implemented.

The embodiments of the present disclosure further provide a non-transitory computer-readable storage medium, where a computer program is stored on the computer-readable storage medium, and when the computer program is executed by a processor, the method according to one or more of the embodiments of the present disclosure is implemented.

Additional aspects and advantages of the embodiments of the present disclosure will be partially set forth in the following description and will become apparent from the following description or learned through practice of the present disclosure.

### BRIEF DESCRIPTION OF THE DRAWINGS

To more clearly illustrate the technical solutions of the embodiments of the present disclosure, the following briefly introduces the figures used in describing the embodiments of the present disclosure. Obviously, the figures described below represent only some embodiments of the present disclosure. Those skilled in the art can derive other figures based on these figures without inventive effort.

FIG. 1 is a schematic diagram of a first example of an embodiment of the present disclosure;

FIG. 2 is a flow chart of a method for sensing measurement setup according to an embodiment of the present disclosure;

FIG. 3 is a flow chart of a method for sensing measurement setup according to an embodiment of the present disclosure;

FIG. 4 is a flow chart of a method for sensing measurement setup according to an embodiment of the present disclosure;

FIG. 5 is a schematic diagram of a structure of an electronic device according to an embodiment of the present disclosure;

FIG. 6 is a schematic diagram of a structure of an electronic device according to an embodiment of the present disclosure;

FIG. 7 is a schematic diagram of a structure of an electronic device according to an embodiment of the present disclosure;

FIG. 8 is a schematic diagram of a structure of an electronic device according to an embodiment of the present disclosure.

### DETAILED DESCRIPTION

Example embodiments will be described in detail herein, as illustrated in the accompanying drawings. Unless otherwise indicated, the following description refers to the accompanying drawings, and like numerals in different figures represent like or similar elements. The embodiments described in the following example embodiments do not represent all embodiments consistent with the present invention. Rather, they are merely examples of apparatus and methods consistent with aspects of the present disclosure, as detailed in the appended claims.

In the embodiments of the present disclosure, the terminology used is for the purpose of describing particular embodiments only and is not intended to be limiting. As used in the present disclosure and the appended claims, the singular forms “a”, “an”, “said” and “the” are intended to include the plural forms, unless the context clearly indicates otherwise. It should also be understood that the term “and/or” as used herein refers to and encompasses any and all possible combinations of one or more of the associated listed items. For example, “A and/or B” may refer to: A alone, A and B simultaneously, or B alone. The character “/” generally indicates an “or” relationship between the associated items. The term “multiple” refers to two or more items. For this reason, in the embodiments of the present disclosure, “multiple” may also be understood to mean “at least two.”

It should be understood that although the present disclosure may use terms such as “first”, “second”, and “third” to describe various types of information, such information should not be limited to these terms. These terms are used solely to distinguish information of the same type from one another. For example, without departing from the scope of the present disclosure, the first information could also be referred to as the second information, and similarly, the second information could also be referred to as the first information. Depending on the context, for example, the term “if” used herein could be interpreted as “upon”, “when” or “in response to determining”.

The following will provide a clear and complete description of the technical solutions in the embodiments of the present disclosure, in conjunction with the accompanying drawings. Obviously, the described embodiments are only some of the embodiments of the present disclosure and do not constitute a complete list. All other embodiments derived by those skilled in the art based on the embodiments of the present disclosure without inventive effort are within the scope of protection of the present disclosure.

The present disclosure provides a method for sensing measurement setup, an electronic device, and a storage medium to further improve the WLAN sensing process to meet wireless sensing requirements.

The method and device are based on the same patent application concept. Since the principles of the method and device are similar, their implementations can be referenced to each other, and any repetitive details will not be repeated.

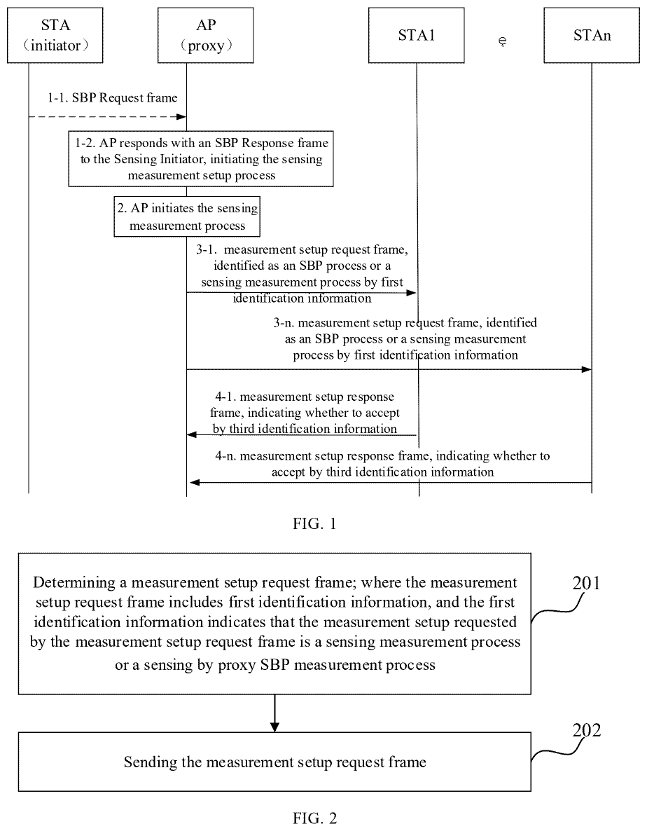

As a first example, refer to FIG. 1, which illustrates an application scenario example of the sensing measurement setup method provided by an embodiment of the present disclosure. In this example, a STA acts as a sensing initiator, and an AP acts as a proxy, conducting multi-link WLAN sensing measurements with STA1 through STAn. The AP can also initiate the sensing measurement process autonomously, with STA1 through STAn acting as responders in the sensing session. As shown in FIG. 1, the process primarily includes the following steps:
Step 1-1: STA (Sensing Initiator) sends an SBP Request frame to AP.
Step 1-2: AP responds with an SBP Response frame to the Sensing Initiator, initiating the sensing measurement setup process.
Step 2: AP can also initiate the sensing measurement process autonomously.

It should be understood that there is no order restriction for executing steps 1 (1-1 and 1-2) and 2.

Thereafter, AP continues executing steps 3-1, . . . , 3-n, sending measurement setup request frames to multiple STAs, each identified as an SBP process or a sensing measurement process by first identification information.

Subsequently, STA1 through STAn may respectively execute steps 4-1, . . . , and 4-n, feeding back a measurement setup response frame to the AP and using third identification information to indicate whether the measurement setup request frame is accepted.

As shown in FIG. 2, an embodiment of the present disclosure provides a method for sensing measurement setup. Alternatively, the method may be applied to an access point (AP). Alternatively, in the embodiment of the present disclosure, the AP is, for example, a device with wireless-to-wired bridging functionality, responsible for extending services provided by the wired network to the wireless network. The station (STA), for example, an electronic device with wireless network access functionality, provides a frame delivery service to facilitate information transmission.

The method may include the following steps:
Step 201: determining a measurement setup request frame; where the measurement setup request frame includes first identification information, indicating that the measurement setup requested by the measurement setup request frame is a sensing measurement process or a sensing by proxy (SBP) measurement process.
Step 202: sending the measurement setup request frame.

WLAN Sensing includes sensing measurement processes and sensing by proxy (SBP) measurement processes. Specifically, an AP can communicate with multiple STAs simultaneously when acting as a Sensing Initiator or Sensing Transmitter, but a STA lacks this functionality. When acting as a Sensing Transmitter, the STA can only communicate one-on-one with a single Sensing Responder, with the AP acting on behalf of the STA to perform the sensing measurement process, known as the SBP process.

During the WLAN Sensing process, AP determines a Measurement Setup Request frame, which is configured to request the setup of a WLAN Sensing process. Specifically, the Measurement Setup Request frame includes first identification information indicating whether the measurement setup requested by the Measurement Setup Request frame is a sensing measurement process or a sensing by proxy SBP measurement process. This facilitates the sensing responder (a STA that has established an initial association with the AP or not) of the Measurement Setup Request frame to learn the type of measurement process requested by the Measurement Setup Request frame.

A sensing responder can accept or reject the sensing measurement process initiated by the AP. For example, if the sensing responder cannot obtain the identity information of the SBP initiator, this may lead to security issues. Therefore, the sensing responder may reject the sensing measurement process initiated by the AP. Therefore, in an embodiment of the present disclosure, first identification information is configured to identify the measurement setup requested by the AP as a sensing measurement process or a sensing by proxy SBP measurement process. This facilitates the sensing responder to determine whether to accept the measurement setup requested by the AP based on the first identification information.

The embodiment of the present disclosure provides a method for sensing measurement setup, applied to an access point device (AP). The method includes:
determining a measurement setup request frame; where the measurement setup request frame includes first identification information, the first identification information indicates that the measurement setup requested by the measurement setup request frame is a sensing measurement process or a sensing by proxy SBP measurement process; and
sending the measurement setup request frame.

The first identification information is carried in the sensing measurement parameter information element (Sensing Measurement Parameters) of the measurement setup request frame. As an example, the format of the Sensing Measurement Parameters is shown in Table 1 below:

TABLE 1

| | Information content | | | | |
|---|---|---|---|---|---|
| | | | Element | Sensing | Sensing |
| | Element | | ID | Measurement | sub- |
| | ID | Length | Extension | Parameter | elements |
| Octets | 1 | 1 | 1 | 5 | variable |

For example, a bit in the reserved field of the Sensing Measurement Parameter field in Table 1 is configured to identify the first identification information. For example, if the first identification information is set to 1, it indicates that the initiated process is an SBP measurement process; for example, if the first identification information is set to 0, it indicates that the initiated process is a sensing measurement process, and the format of the Sensing Measurement Parameter field is shown in Table 2 below:

TABLE 2

| | | | Sensing | Measurement | | | |
|---|---|---|---|---|---|---|---|
| | | | Measurement | Setup | | Max TX | Max RX |
| Information | Sensing | Sensing | Report | Expiry | | HE-LTF | HE-LTF |
| content | Transmitter | Receiver | Requested | Exponent | BW | Repetition | Repetition |
| Bits | 1 | 1 | 1 | 4 | 4 | 3 | 3 |

| | Max | Max | Number of | | | | | |
|---|---|---|---|---|---|---|---|---|
| Information | TX | RX | RX | Report | | | BSS Color | |
| content | STS | STS | Antennas | Timestamp | N_{b} | I_{Ng} | Information | Reserved |
| Bits | 3 | 3 | 3 | 1 | 1 | 1 | 8 | 4 |

The embodiment of the present disclosure provides a method for sensing measurement setup, applied to an access point device (AP). The method includes:
determining a measurement setup request frame; where the measurement setup request frame includes first identification information, and the first identification information indicates that the measurement setup requested by the measurement setup request frame is a sensing measurement process or a sensing by proxy SBP measurement process; and
sending the measurement setup request frame.

The measurement setup request frame includes second identification information, and the second identification information identifies whether the SBP initiator of the SBP measurement process is an associated STA or an unassociated STA of the AP. The associated STA is a STA that has established an initial association with the AP, and the unassociated STA is a STA that has not established an initial association with the AP. When a STA establishes an initial association, for example, when a STA attempts to associate with the AP, the STA sends an association request frame to the AP. The AP responds to the association request frame with an association response frame and assigns an AID to the STA. For example, the second identification information set to 1 indicates an associated STA initiating the SBP measurement process, while the second identification information set to 0 indicates an unassociated STA initiating the SBP measurement process. The sensing responder can reject the SBP measurement process initiated by the unassociated STA.

The embodiment of the present disclosure provides a method for sensing measurement setup, applied to an access point device (AP). The method includes:
determining a measurement setup request frame; where the measurement setup request frame includes first identification information, and the first identification information indicates that the measurement setup requested by the measurement setup request frame is a sensing measurement process or a sensing by proxy SBP measurement process; and
sending the measurement setup request frame.

The measurement setup request frame includes second identification information, and the second identification information identifies whether the SBP initiator of the SBP measurement process is an associated STA or an unassociated STA of the AP.

The second identification information is carried in:
the Sensing Measurement Parameter information element of the measurement setup request frame, or the TB Sensing Specific sub-element of the measurement setup request frame. The second identification information is carried in the Sensing Measurement Parameter information element of the measurement setup request frame. For example, a bit in the Reserved field of the Sensing Measurement Parameter field in Table 1 may also be used to identify whether the SBP initiator is an associated STA or an unassociated STA.

The second identification information may also be carried in a TB Sensing Specific sub-element. As an example, the format of the TB Sensing Specific sub-element is shown in Table 3 below:

TABLE 3

| | Sub- | | | | CSI | | | |
|---|---|---|---|---|---|---|---|---|
| | element | | | Poll | Variation | | | Availability |
| Content | ID | Length | AID/USID | Assigned | Threshold | SR2SR | Reserved | Window |
| Bits | 8 | 8 | 16 | 1 | 4 | 1 | 2 | 64 |

The second identification information may be carried in the Reserved field of the TB sensing specific sub-element.

The embodiment of the present disclosure provides a method for sensing measurement setup, applied to an access point device (AP). The method includes:
receiving an SBP request frame sent by an SBP initiator;
determining the second identification information based on the TA information in the SBP request frame;
determining a measurement setup request frame; where the measurement setup request frame includes first identification information indicating whether the measurement setup requested by the measurement setup request frame is a sensing measurement process or a sensing by proxy SBP measurement process; and
sending the measurement setup request frame.

The measurement setup request frame includes second identification information, and the second identification information identifies whether the SBP initiator of the SBP measurement process is an associated STA or an unassociated STA of the AP.

The SBP request frame includes information elements such as SBP parameters. The AP determines whether the SBP initiator (STA) has established an initial association with the AP based on the TA (transmitter address) in the received SBP request frame. For example, the AP may record the TA of a STA that has established an initial association.

In addition, the SBP parameters information element further includes parameter information such as the number of STAs participating in the SBP sensing measurement, the sensing measurement bandwidth, etc.

The embodiment of the present disclosure provides a method for sensing measurement setup, applied to an access point device (AP). The method includes:
receiving an SBP request frame sent by an SBP initiator;
determining the second identification information based on the TA information in the SBP request frame;
determining a measurement setup request frame; where the measurement setup request frame includes first identification information, and the first identification information indicates that the measurement setup requested by the measurement setup request frame is a sensing measurement process or a sensing by proxy SBP measurement process; and
sending the measurement setup request frame.

The measurement setup request frame includes second identification information, and the second identification information identifies whether the SBP initiator of the SBP measurement process is an associated STA or an unassociated STA of the AP.

If the SBP initiator is an unassociated STA of the AP and participates in the sensing measurement, a user identification (USID) is assigned to the SBP initiator. Specifically, if the SBP initiator is an unassociated STA and subsequently, as a sensing responder, participates in the sensing measurement process initiated by the AP as a proxy, the AP must assign a user identification (USID) to the SBP initiator to facilitate the identification of the identity information of the SBP initiator during the sensing measurement process.

The embodiment of the present disclosure provides a method for sensing measurement setup, applied to an access point device (AP). The method includes:
determining a measurement setup request frame; where the measurement setup request frame includes first identification information, and the first identification information indicates whether the measurement setup requested by the measurement setup request frame is a sensing measurement process or a sensing by proxy SBP measurement process; and
sending the measurement setup request frame;
receiving a measurement setup response frame sent by a sensing responder; where the measurement setup response frame includes third identification information, and the third identification information indicates whether the sensing responder accepts the measurement setup request. A sensing responder can accept or reject the sensing measurement process initiated by the AP. The sensing responder uses a measurement setup response frame carrying third identification information to provide feedback on whether it accepts the measurement setup request.

The embodiment of the present disclosure provides a method for sensing measurement setup, applied to an access point device (AP). The method includes:
determining a measurement setup request frame; where the measurement setup request frame includes first identification information, and the first identification information indicates that the measurement setup requested by the measurement setup request frame is a sensing measurement process or a sensing by proxy SBP measurement process; and
sending the measurement setup request frame.

Alternatively, the first identification information is carried in a sensing measurement parameter information element of the measurement setup request frame.

Alternatively, the measurement setup request frame includes second identification information, and the second identification information identifies whether the SBP initiator of the SBP measurement process is an associated STA or an unassociated STA of the AP.

Alternatively, the second identification information is carried in:
the sensing measurement parameter information element of the measurement setup request frame, or the TB sensing specific sub-element of the measurement setup request frame.

Alternatively, before determining the measurement setup request frame, the method includes:
receiving an SBP request frame sent by an SBP initiator; and
determining the second identification information based on the TA information in the SBP request frame.

Alternatively, the SBP initiator is an unassociated STA of the AP and participates in the sensing measurement, and a user identification (USID) is assigned to the SBP initiator.

Alternatively, after sending the measurement setup request frame, the method further includes:
receiving a measurement setup response frame sent by a sensing responder; where the measurement setup response frame includes third identification information, and the third identification information indicates whether the sensing responder accepts the measurement setup request.

In the embodiment of the present disclosure, the AP determines a measurement setup request. The measurement setup request frame includes first identification information. The first identification information indicates whether the measurement setup requested by the measurement setup request frame is a sensing measurement process or a sensing by proxy SBP measurement process. This facilitates a sensing responder receiving the measurement setup request frame to learn the type of measurement process requested by the measurement setup request frame and determine whether to accept the measurement setup request frame based on the first identification information. The embodiment of the present disclosure provides a method for sensing measurement setup to further improve the WLAN Sensing process and meet wireless sensing requirements.

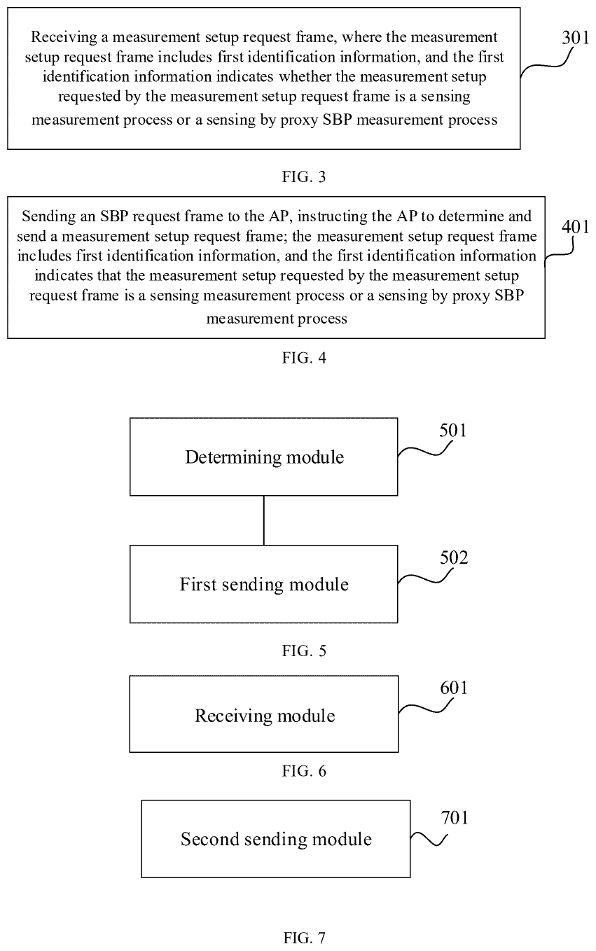

Referring to FIG. 3, the embodiment of the present disclosure provides a method for sensing measurement setup. Alternatively, the method can be applied to a sensing responder. The sensing responder can be a STA that has established an initial association with the AP or not. The method may include the following steps:
Step 301: receiving a measurement setup request frame, where the measurement setup request frame includes first identification information, and the first identification information indicates whether the measurement setup requested by the measurement setup request frame is a sensing measurement process or a sensing by proxy SBP measurement process.

In WLAN Sensing, there are a sensing measurement processes and an SBP measurement process. Specifically, while an AP can communicate with multiple STAs simultaneously when acting as a Sensing Initiator or Sensing Transmitter, a STA lacks this functionality and can only communicate one-on-one with a single responder. The AP then proxies the STA to perform the sensing measurement process, known as the SBP process.

A sensing responder receives a measurement setup request frame sent by the AP during the WLAN Sensing process. The measurement setup request frame is configured to request the setup of a WLAN Sensing process. Specifically, the measurement setup request frame includes first identification information indicating whether the measurement setup requested by the measurement setup request frame is a sensing measurement process or a sensing by proxy SBP measurement process. This facilitates the sensing responder (a STA that has established an initial association with the AP or not) receiving the measurement setup request frame to determine the type of measurement process requested by the measurement setup request frame.

A sensing responder can either accept or reject the sensing measurement process initiated by the AP. For example, if the sensing responder cannot obtain the identity information of the SBP initiator, this may lead to security issues, so the sensing responder may reject the sensing measurement process initiated by the AP. Therefore, in the embodiment of the present disclosure, the first identification information is configured to identify the measurement setup requested by the AP as a sensing measurement process or a sensing by proxy SBP measurement process, facilitating the sensing responder to determine whether to accept the measurement setup request based on the first identification information.

The embodiment of the present disclosure provides a method for sensing measurement setup, which can alternatively be applied to a sensing responder. The method may include the following steps:
receiving a measurement setup request frame; where the measurement setup request frame includes first identification information, and the first identification information indicates whether the measurement setup requested by the measurement setup request frame is a sensing measurement process or a sensing by proxy SBP measurement process.

The first identification information is carried in the Sensing Measurement Parameter information element of the measurement setup request frame. For example, the format of the Sensing Measurement Parameter is as shown in Table 1. For example, one bit in the Reserved field of the Sensing Measurement Parameter field in Table 1 is configured to identify the first identification information. For example, if the first identification information is set to 1, it indicates that an SBP measurement process is initiated; for example, if the first identification information is set to 0, it indicates that a sensing measurement process is initiated, and the format of the Sensing Measurement Parameter field is as shown in Table 2, which is not further described here.

The embodiment of the present disclosure provides a method for sensing measurement setup. Alternatively, the method can be applied to a sensing responder. The method may include the following steps:
receiving a measurement setup request frame; where the measurement setup request frame includes first identification information, and the first identification information indicates that the measurement setup requested by the measurement setup request frame is a sensing measurement process or a sensing by proxy SBP measurement process.

The measurement setup request frame includes second identification information, and the second identification information identifies whether the SBP initiator of the SBP measurement process is an associated STA or an unassociated STA of the AP. For example, setting the second identification information to 1 indicates an associated STA initiating the SBP measurement process, while setting the second identification information to 0 indicates an unassociated STA initiating the SBP measurement process. A sensing responder can reject an SBP measurement process initiated by an unassociated STA.

The embodiment of the present disclosure provides a method for sensing measurement setup. Alternatively, the method can be applied to a sensing responder. The method can include the following steps:
receiving a measurement setup request frame; where the measurement setup request frame includes first identification information, and the first identification information indicates that the measurement setup requested by the measurement setup request frame is a sensing measurement process or a sensing by proxy SBP measurement process.

The measurement setup request frame includes second identification information, and the second identification information identifies whether the SBP initiator of the SBP measurement process is an associated STA or an unassociated STA of the AP.

The second identification information is carried in:
the sensing measurement parameter information element of the measurement setup request frame, or the TB sensing specific sub-element of the measurement setup request frame. The second identification information is carried in the sensing measurement parameter information element of the measurement setup request frame. For example, a bit in the reserved field of the Sensing Measurement Parameter field in Table 1 can be configured to identify whether the SBP initiator is an associated STA or an unassociated STA.

The second identification information may also be carried in a TB Sensing Specific sub-element. For example, the format of the TB Sensing Specific sub-element is shown in Table 3. The second identification information may be carried in the Reserved field of the TB Sensing Specific sub-element.

The embodiment of the present disclosure provides a method for sensing measurement setup. Alternatively, the method may be applied to a sensing responder. The method may include the following steps:
receiving a measurement setup request frame; where the measurement setup request frame includes first identification information, and the first identification information indicates that the measurement setup requested by the measurement setup request frame is a sensing measurement process or a sensing by proxy SBP measurement process.
sending a measurement setup response frame to an access point device (AP); where the measurement setup response frame includes third identification information, and the third identification information indicates whether the sensing responder accepts the measurement setup request. The sensing responder may accept or reject the sensing measurement process initiated by the AP. The sensing responder uses the measurement setup response frame to carry the third identification information to provide feedback on whether it accepts the measurement setup request.

The embodiment of the present disclosure provides a method for sensing measurement setup. Alternatively, the method may be applied to a sensing responder. The method may include the following steps:
receiving a measurement setup request frame; where the measurement setup request frame includes first identification information, and the first identification information indicates that the measurement setup requested by the measurement setup request frame is a sensing measurement process or a sensing by proxy SBP measurement process; and
sending a measurement setup response frame to an access point device (AP); where the measurement setup response frame includes third identification information, and the third identification information indicates whether the sensing responder accepts the measurement setup request.

If the second identification information indicates that the SBP initiator of the SBP measurement process is an unassociated STA of the AP, the third identification information indicates that the sensing responder rejects the measurement setup request. That is, for an SBP process initiated by a non-associated STA, since it is difficult to verify the identity information of the unassociated STA, the sensing responder may reject the measurement setup request.

The embodiment of the present disclosure provides a method for sensing measurement setup. Alternatively, the method may be applied to a sensing responder. The method may include the following steps:
receiving a measurement setup request frame; wherein the measurement setup request frame includes first identification information, and the first identification information indicates that the measurement setup requested by the measurement setup request frame is a sensing measurement process or a sensing by proxy SBP measurement process.

Alternatively, the first identification information is carried in the sensing measurement parameter information element of the measurement setup request frame.

Alternatively, the measurement setup request frame includes second identification information, and the second identification identifies whether the SBP initiator of the SBP measurement process is an associated STA or an unassociated STA of the AP.

Alternatively, the second identification information is carried in:
the sensing measurement parameter information element of the measurement setup request frame, or the TB sensing specific sub-element of the measurement setup request frame.

Alternatively, after receiving the measurement setup request frame, the method further includes:
sending a measurement setup response frame to an access point device (AP); where the measurement setup response frame includes third identification information, and the third identification information identifies whether the sensing responder accepts the measurement setup request.

Alternatively, if the second identification information identifies the SBP initiator of the SBP measurement process as an unassociated STA of the AP, the third identification information indicates that the sensing responder rejects the measurement setup request.

In the embodiment of the present disclosure, the sensing responder receives a measurement setup request frame; the measurement setup request frame includes first identification information. The sensing responder learns the type of measurement process requested by the measurement setup request frame based on the first identification information and determines whether to accept the measurement setup request frame based on the third identification information. The embodiment of the present disclosure provides a method for sensing measurement setup to further improve the WLAN sensing process and meet wireless sensing requirements.

Referring to FIG. 4, the embodiment of the present disclosure provides a method for sensing measurement setup. Alternatively, the method can be applied to a sensing by proxy SBP initiator, which can be an associated STA or an unassociated STA of the AP. The method can include the following steps:

Step 401: sending an SBP request frame to the AP, instructing the AP to determine and send a measurement setup request frame; the measurement setup request frame includes first identification information, and the first identification information indicates that the measurement setup requested by the measurement setup request frame is a sensing measurement process or a sensing by proxy SBP measurement process.

In WLAN Sensing, there are a sensing measurement processes and a sensing by proxy (SBP) measurement process. Specifically, while an AP can communicate with multiple STAs simultaneously when acting as a Sensing Initiator or Sensing Transmitter, a STA lacks this functionality. When acting as a sensing transmitter, the STA can only communicate one-to-one with a single responder (Sensing Responder). The AP then proxies the STA to perform the sensing measurement process, known as the SBP process. In the embodiment of the present disclosure, the SBP initiator sends an SBP request frame to the AP, requesting the AP to proxy the STA to perform the sensing measurement process and instructing the AP to determine a measurement setup request frame. The measurement setup request frame is configured to request the setup of the WLAN sensing process. Specifically, the measurement setup request frame includes first identification information, indicating whether the measurement setup requested by the measurement setup request frame is a sensing measurement process or a sensing by proxy SBP measurement process. This facilitates the sensing responder (a STA that has established an initial association with the AP or not) receiving the measurement setup request frame to determine the type of measurement process requested by the measurement setup request frame.

A sensing responder can either accept or reject the sensing measurement process initiated by the AP. For example, if the sensing responder cannot obtain the identity information of the SBP initiator, this may lead to some security issues, so the sensing responder may reject the sensing measurement process initiated by the AP. Therefore, in the embodiment of the present disclosure, the measurement setup requested by the AP is identified as a sensing measurement process or a sensing by proxy SBP measurement process through the first identification information, so that the sensing responder can determine whether to accept the measurement setup requested by the AP based on the first identification information.

The embodiment of the present disclosure provides a method for sensing measurement setup. Alternatively, the method can be applied to a sensing by proxy SBP initiator, which can be an associated STA or an unassociated STA of an AP. The method can include the following steps:
sending an SBP request frame to the AP, instructing the AP to determine and send a measurement setup request frame; where the measurement setup request frame includes first identification information, and the first identification information indicates whether the measurement setup requested by the measurement setup request frame is a sensing measurement process or a sensing by proxy SBP measurement process.

The first identification information is carried in the sensing measurement parameter information element (Sensing Measurement Parameters) of the measurement setup request frame. As an example, the format of the Sensing Measurement Parameter is as shown in Table 1 above. For example, one bit in the reserved field of the Sensing Measurement Parameter field in Table 1 is configured to identify the first identification information. For example, if the first identification information is set to 1, it indicates that an SBP measurement process is initiated; if the first identification information is set to 0, it indicates that a sensing measurement process is initiated, and the format of the Sensing Measurement Parameter field is as shown in Table 2 above.

The embodiment of the present disclosure provides a method for sensing measurement setup. Alternatively, the method can be applied to a sensing by proxy SBP initiator, where the SBP initiator can be an associated STA or an unassociated STA of an AP. The method can include the following steps:
sending an SBP request frame to an AP, instructing the AP to determine and send a measurement setup request frame; where the measurement setup request frame includes first identification information, and the first identification information indicates that the measurement setup requested by the measurement setup request frame is a sensing measurement process or a sensing by proxy SBP measurement process.

The measurement setup request frame includes second identification information, and the second identification identifies the SBP initiator of the SBP measurement process as an associated STA or an unassociated STA of the AP. The associated STA is a STA that has established an initial association with the AP, and the unassociated STA is a STA that has not established an initial association with the AP. For example, when a STA attempts to associate with an AP, the STA sends an association request frame to the AP. The AP responds to the association request frame with an association response frame and assigns an AID to the STA. For example, setting the second identification information to 1 indicates an associated STA initiating the measurement, while setting the second identification information to 0 indicates an unassociated STA initiating the measurement. A sensing responder can reject an SBP measurement process initiated by an unassociated STA.

The embodiment of the present disclosure provides a method for sensing measurement setup. Alternatively, the method can be applied to a sensing by proxy SBP initiator. The SBP initiator can be an associated STA or an unassociated STA of an AP. The method can include the following steps:
sending an SBP request frame to an AP, instructing the AP to determine and send a measurement setup request frame; where the measurement setup request frame includes first identification information, and the first identification information indicates that the measurement setup requested by the measurement setup request frame is a sensing measurement process or a sensing by proxy SBP measurement process.

The measurement setup request frame includes second identification information, and the second identification information indicates that the SBP initiator of the SBP measurement process is an associated STA or an unassociated STA of the AP.

The second identification information is carried in:
the Sensing Measurement Parameters information element of the measurement setup request frame, or the TB Sensing Specific sub-element of the measurement setup request frame. The second identification information is carried in the Sensing Measurement Parameters information element of the measurement setup request frame. For example, one bit in the Reserved field of the Sensing Measurement Parameter field in Table 1 may be configured to identify whether the SBP initiator is an associated STA or an unassociated STA. The second identification information may also be carried in the TB Sensing Specific sub-element. As an example, the format of the TB Sensing Specific sub-element is shown in Table 3.

The embodiment of the present disclosure provides a method for sensing measurement setup. Alternatively, the method may be applied to a sensing by proxy SBP initiator, and the SBP initiator may be an associated STA or an unassociated STA of an AP. The method may include the following steps:
sending an SBP request frame to an AP, instructing the AP to determine and send a measurement setup request frame; where the measurement setup request frame includes first identification information, and the first identification information indicates whether the measurement setup requested by the measurement setup request frame is a sensing measurement process or a sensing by proxy SBP measurement process.

The measurement setup request frame includes second identification information, and the second identification identifies whether the SBP initiator of the SBP measurement process is an associated STA or an unassociated STA of the AP.

The second identification information is determined based on the TA information in the SBP request frame. The SBP request frame includes information elements such as SBP parameters. The AP determines whether the SBP initiator STA has established an initial association with the AP based on the TA (transmitter address) in the received SBP request frame. For example, the AP records the TA of the STA that has established an initial association.

In addition, the SBP parameters information element also includes parameter information such as the number of STAs participating in the SBP sensing measurement and the sensing measurement bandwidth, etc.

The embodiment of the present disclosure provides a method for sensing measurement setup. Alternatively, the method can be applied to a sensing by proxy SBP initiator, which can be an associated STA or an unassociated STA of the AP. The method can include the following steps:

sending an SBP request frame to the AP, instructing the AP to determine and send a measurement setup request frame; the measurement setup request frame includes first identification information, and the first identification information indicates whether the measurement setup requested by the measurement setup request frame is a sensing measurement process or a sensing by proxy SBP measurement process.

The SBP initiator is an unassociated STA of the AP, and the SBP initiator participates in the sensing measurement and receives a user identification (USID) assigned by the AP to the SBP initiator.

The embodiment of the present disclosure provides a method for sensing measurement setup. Alternatively, the method can be applied to a sensing by proxy SBP initiator, which can be an associated or unassociated STA of the AP. The method can include the following steps:
sending an SBP request frame to the AP, instructing the AP to determine and send a measurement setup request frame; the measurement setup request frame includes first identification information, and the first identification information indicates that the measurement setup requested by the measurement setup request frame is a sensing measurement process or a sensing by proxy SBP measurement process.

Alternatively, the first identification information is carried in the sensing measurement parameter information element of the measurement setup request frame.

Alternatively, the measurement setup request frame includes second identification information, indicating that the SBP initiator of the SBP measurement process is an associated or unassociated STA of the AP.

Alternatively, the second identification information is carried in:
the sensing measurement parameter information element of the measurement setup request frame, or the TB sensing specific sub-element of the measurement setup request frame.

Alternatively, the second identification information is determined based on TA information in the SBP request frame.

Alternatively, the method further includes:

The SBP initiator is an unassociated STA of the AP, and the SBP initiator participates in sensing measurement and receives a user identification (USID) assigned by the AP to the SBP initiator.

In the embodiment of the present disclosure, the SBP initiator sends an SBP request frame to the AP, instructing the AP to determine and send a measurement setup request frame. The measurement setup request frame includes first identification information, and the first identification information indicates whether the measurement setup requested by the measurement setup request frame is a sensing measurement process or a sensing by proxy SBP measurement process. This facilitates a sensing responder receiving the measurement setup request frame to learn the type of measurement process requested by the measurement setup request frame and determine whether to accept the measurement setup request frame based on the first identification information. The embodiment of the present disclosure provides a method for sensing measurement setup to further improve the WLAN sensing process and meet wireless sensing requirements.

Referring to FIG. 5, based on the same principles as the method provided in the embodiments of the present disclosure, the embodiments of the present disclosure further provide an electronic device, which is an access point device (AP). The electronic device includes:
a determining module 501, configured to determine a measurement setup request frame; where the measurement setup request frame includes first identification information, and the first identification information indicates that the measurement setup requested by the measurement setup request frame is a sensing measurement process or a sensing by proxy SBP measurement process; and
a first sending module 502, configured to send the measurement setup request frame.

The embodiments of the present disclosure further provide a device for sensing measurement setup, applied to an access point device (AP). The device includes:
a request determining module, configured to determine a measurement setup request frame; where the measurement setup request frame includes first identification information, and the first identification information indicates that the measurement setup requested by the measurement setup request frame is a sensing measurement process or a sensing by proxy SBP measurement process; and
a first request sending module, configured to send the measurement setup request frame.

The device further includes other modules of the electronic device in the aforementioned embodiments, which are not described here in detail.

Referring to FIG. 6, based on the same principles as the method provided in the embodiments of the present disclosure, the embodiments of the present disclosure further provide an electronic device, the electronic device being an access point device (AP), including:
a receiving module 601 configured to receive a measurement setup request frame; where the measurement setup request frame includes first identification information indicating that the measurement setup requested by the measurement setup request frame is a sensing measurement process or a sensing by proxy SBP measurement process.

The embodiment of the present disclosure also provides a device for sensing measurement setup, applied to an access point device (AP). The device includes:
a request receiving module, configured to receive a measurement setup request frame; where the measurement setup request frame includes first identification information indicating that the measurement setup requested by the measurement setup request frame is a sensing measurement process or a sensing by proxy SBP measurement process.

The device further includes other modules of the electronic device described in the aforementioned embodiments, which are not described here.

Referring to FIG. 7, based on the same principles as the method provided in the embodiment of the present disclosure, the embodiment of the present disclosure also provides an electronic device, which is a sensing by proxy SBP initiator. The electronic device includes:
a second sending module 701, configured to send an SBP request frame to the AP, instructing the AP to determine and send the measurement setup request frame; the measurement setup request frame includes first identification information indicating that the measurement setup requested by the measurement setup request frame is a sensing measurement process or a sensing by proxy SBP measurement process.

The embodiment of the present disclosure also provides a device for sensing measurement setup, applied to an access point device (AP). The device includes:
a second request sending module, configured to send an SBP request frame to the AP, instructing the AP to determine and send a measurement setup request frame; the measurement setup request frame includes first identification information indicating that the measurement setup requested by the measurement setup request frame is a sensing measurement process or a sensing by proxy SBP measurement process.

The device further includes other modules of the electronic device described in the aforementioned embodiments, which are not described here.

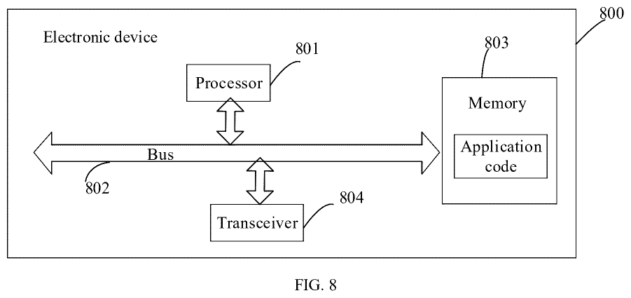

In an embodiment, the embodiment of the present disclosure also provides an electronic device, as shown in FIG. 8. The electronic device 800 shown in FIG. 8 may be a server, including a processor 801 and a memory 803. The processor 801 and the memory 803 are connected, for example, via a bus 802. Alternatively, the electronic device 800 may further include a transceiver 804. It should be noted that in actual applications, there is not limited to one transceiver 804, and the structure of the electronic device 800 does not constitute a limitation of the present disclosure.

The processor 801 may be a CPU (Central Processing Unit), a general-purpose processor, a DSP (Digital Signal Processor), an ASIC (Application Specific Integrated Circuit), an FPGA (Field Programmable Gate Array), or other programmable logic devices, transistor logic devices, hardware components, or any combination thereof. It may implement or execute the various exemplary logic blocks, modules, and circuits described in conjunction with the present disclosure. The processor 801 may also be a combination of components that implement computing functions, such as a combination of one or more microprocessors, a combination of a DSP and a microprocessor, etc.

The bus 802 may include a path for transmitting information between the aforementioned components. The bus 802 may be a PCI (Peripheral Component Interconnect) bus or an EISA (Extended Industry Standard Architecture) bus, etc. The bus 802 may be classified into an address bus, a data bus, a control bus, etc. For ease of illustration, FIG. 8 shows only a single thick line, but this does not imply that there is only one bus or only one type of bus.

The memory 803 can be, but is not limited to, ROM (Read Only Memory) or other types of static storage devices capable of storing static information and instructions, RAM (Random Access Memory) or other types of dynamic storage devices capable of storing information and instructions, EEPROM (Electrically Erasable Programmable Read Only Memory), CD-ROM (Compact Disc Read Only Memory) or other optical disk storage, optical disk storage (including Compact Disc, Laser Disc, Optical Disc, Digital Versatile Disc, Blu-ray Disc, etc.), magnetic disk storage media or other magnetic storage devices, or any other medium capable of carrying or storing desired program code in the form of instructions or data structures and accessible by a computer.

The memory 803 is configured to store application code for implementing the solution of the present disclosure and is controlled for execution by the processor 801. The processor 801 is configured to execute the application code stored in memory 803 to implement the contents of the aforementioned method embodiment.

The electronic device includes, but is not limited to, a mobile terminal such as a mobile phone, a laptop, a digital broadcast receiver, a PDA (personal digital assistant), a PAD (tablet computer), a PMP (portable multimedia player), an in-vehicle terminal (e.g., in-vehicle navigation terminal), and a fixed terminal such as a digital TV and a desktop computer. The electronic device shown in FIG. 8 is merely an example and should not limit the functionality or scope of use of the embodiments of the present disclosure.

The server provided in the embodiment of the present disclosure may be a standalone physical server, a server cluster or distributed system consisting of multiple physical servers, or a cloud server providing basic cloud computing services such as cloud services, cloud databases, cloud computing, cloud functions, cloud storage, network services, cloud communications, middleware services, domain name services, security services, CDNs, and big data and artificial intelligence platforms. The terminal may be, but is not limited to, a smartphone, a tablet, a laptop, a desktop computer, a smart speaker, a smart watch, and the like. The terminal and the server may be connected directly or indirectly via wired or wireless communications, which is not a limitation of the present disclosure.

The embodiment of the present disclosure provides a computer-readable storage medium storing a computer program that, when executed on a computer, enables the computer to execute the corresponding content of the aforementioned method embodiments.

It should be understood that although the steps in the flowcharts of the accompanying drawings are shown sequentially as indicated by the arrows, these steps are not necessarily executed in the order indicated by the arrows. Unless otherwise specified herein, the execution of these steps is not strictly limited to a specific order and may be performed in other orders. Furthermore, at least some of the steps in the flowcharts of the accompanying drawings may include multiple sub-steps or multiple stages. These sub-steps or stages are not necessarily executed at the same time, but may be executed at different times. Their execution order is not necessarily sequential, but may be performed in turn or alternatively with other steps or subs-steps of other steps or at least a portion of stages.

It should be noted that the computer-readable medium mentioned in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, device, or any combination thereof. More specific examples of computer-readable storage media may include, but are not limited to, an electrical connection having one or more conductors, a portable computer disk, a hard disk, random access memory (RAM), read-only memory (ROM), erasable programmable read-only memory (EPROM or flash memory), optical fiber, a portable compact disk read-only memory (CD-ROM), an optical storage device, a magnetic storage device, or any suitable combination thereof. In the present disclosure, the computer-readable storage medium may be any tangible medium containing or storing a program for use by or in conjunction with an instruction execution system, apparatus, or device. In the present disclosure, the computer-readable signal medium may include a data signal propagated in baseband or as part of a carrier wave, carrying computer-readable program codes. Such a propagated data signal may take a variety of forms, including, but not limited to, electromagnetic signals, optical signals, or any suitable combination thereof. The computer-readable signal medium may also be any computer-readable medium other than a computer-readable storage medium that can transmit, propagate, or transport a program for use by or in conjunction with an instruction execution system, apparatus, or device. Program code carried on a computer-readable medium may be transmitted using any suitable medium, including, but not limited to, wires, optical cables, RF (radio frequency), or any suitable combination thereof.

The computer-readable medium may be included in the electronic device, or it may exist separately and not be incorporated into the electronic device.

The computer-readable medium carries one or more programs. When executed by the electronic device, the one or more programs cause the electronic device to perform the methods described in the above embodiments.

According to one aspect of the present disclosure, a computer program product or computer program is provided. The computer program product or computer program includes computer instructions stored in a computer-readable storage medium. A processor of a computer device reads the computer instructions from the computer-readable storage medium and executes the computer instructions, causing the computer device to perform the methods provided in the various embodiments described above.

The computer program code for performing the operations of the present disclosure may be written in one or more programming languages, or a combination thereof. The programming languages include object-oriented programming languages such as Java, Smalltalk, and C++, as well as conventional procedural programming languages such as C or similar programming languages. The program code may be executed entirely on a user's computer, partially on a user's computer, as a standalone software package, partially on a user's computer and partially on a remote computer, or entirely on a remote computer or server. In cases involving a remote computer, the remote computer can be connected to the user computer via any type of network, including a local area network (LAN) or a wide area network (WAN), or can be connected to an external computer (e.g., via the Internet using an Internet service provider).

The flowcharts and block diagrams in the accompanying drawings illustrate the architecture, functionality, and operation of possible implementations of the systems, methods, and computer program products according to various embodiments of the present disclosure. In this regard, each block in the flowchart or block diagram may represent a module, program segment, or portion of code, which contains one or more executable instructions for implementing the specified logical function. It should also be noted that in some alternative implementations, the functions noted in the blocks may occur in a different order than that noted in the accompanying drawings. For example, two blocks shown in succession may actually be executed substantially in parallel, or they may sometimes be executed in the opposite order, depending on the functions involved. It should also be noted that each block in the block diagrams and/or flowcharts, as well as combinations of blocks in the block diagrams and/or flowcharts, can be implemented using a dedicated hardware-based system that performs the specified functions or operations, or can be implemented using a combination of dedicated hardware and computer instructions.

The modules described in the embodiments of this disclosure may be implemented in software or hardware. The name of a module does not, in some cases, limit the module itself. For example, module A could also be described as “module A for performing operation B.”

The above description is merely a preferred embodiment of the present disclosure and an illustration of the technical principles employed. Those skilled in the art should understand that the scope of the present disclosure is not limited to technical solutions formed by specific combinations of the aforementioned technical features, but also encompasses other technical solutions formed by any combination of the aforementioned technical features or their equivalents without departing from the scope of the disclosure, for example, technical solutions formed by replacing the aforementioned features with (but not limited to) technical features with similar functions disclosed in this disclosure.

1. A method for sensing measurement setup, performed by an access point device (AP), comprising:
determining a measurement setup request frame; wherein the measurement setup request frame comprises first identification information, and the first identification information indicates that a measurement setup requested by the measurement setup request frame is a sensing measurement process or a sensing by proxy (SBP) measurement process; and
sending the measurement setup request frame.

2. The method for sensing measurement setup according to claim 1, wherein the first identification information is carried in a sensing measurement parameter information element of the measurement setup request frame.

3. The method for sensing measurement setup according to claim 1, wherein the measurement setup request frame comprises second identification information, and the second identification information identifies whether an SBP initiator of the SBP measurement process is an associated station (STA) or an unassociated STA of the AP.

4. The method for sensing measurement setup according to claim 3, wherein the second identification information is carried in:
a sensing measurement parameter information element of the measurement setup request frame, or a trigger-based (TB) sensing specific sub-element of the measurement setup request frame.

5. The method for sensing measurement setup according to claim 3, further comprising:
receiving an SBP request frame sent by the SBP initiator; and
determining the second identification information based on a transmitter address (TA) information in the SBP request frame.

6. The method for sensing measurement setup according to claim 5, wherein
the SBP initiator is the unassociated STA of the AP, and the SBP initiator participates in the sensing measurement, and a user identification (USID) is assigned to the SBP initiator.

7. The method for sensing measurement setup according to claim 1, further comprising:
receiving a measurement setup response frame sent by a sensing responder; wherein the measurement setup response frame includes third identification information, and the third identification information identifies whether the sensing responder accepts the measurement setup request.

8. A method for sensing measurement setup, performed by a sensing responder, comprising:
receiving a measurement setup request frame; wherein the measurement setup request frame comprises first identification information, and the first identification information indicates whether a measurement setup requested by the measurement setup request frame is a sensing measurement process or a sensing by proxy (SBP) measurement process.

9. The method for sensing measurement setup according to claim 8, wherein the first identification information is carried in a sensing measurement parameter information element of the measurement setup request frame.

10. The method for sensing measurement setup according to claim 8, wherein the measurement setup request frame comprises second identification information, and the second identification information identifies whether an SBP initiator of the SBP measurement process is an associated station (STA) or an unassociated STA of an AP.

11. The method for sensing measurement setup according to claim 10, wherein the second identification information is carried in:
a sensing measurement parameter information element of the measurement setup request frame, or a trigger-based (TB) sensing specific sub-element of the measurement setup request frame.

12. The method for sensing measurement setup according to claim 10, further comprising:
sending a measurement setup response frame to an access point device (AP); wherein the measurement setup response frame comprises third identification information, and the third identification information identifies whether the sensing responder accepts the measurement setup request.

13. The method for sensing measurement setup according to claim 12, wherein the second identification information identifies the SBP initiator of the SBP measurement process as the unassociated STA of the AP, and the third identification information identifies the sensing responder rejecting the measurement setup request.

14. A method for sensing measurement setup, performed by a sensing by proxy (SBP) initiator, comprising:
sending an SBP request frame to an access point device (AP), instructing the AP to determine and send a measurement setup request frame; wherein the measurement setup request frame comprises first identification information, and the first identification information indicates that a measurement setup requested by the measurement setup request frame is a sensing measurement process or a SBP measurement process.

15. The method for sensing measurement setup according to claim 14, wherein the first identification information is carried in a sensing measurement parameter information element of the measurement setup request frame.

16. The method for sensing measurement setup according to claim 14, wherein the measurement setup request frame comprises second identification information, and the second identification information identifies whether an SBP initiator of the SBP measurement process is an associated station (STA) or an unassociated STA of the AP.

17. The method for sensing measurement setup according to claim 16, wherein the second identification information is carried in:
a sensing measurement parameter information element of the measurement setup request frame, or a trigger-based (TB) sensing specific sub-element of the measurement setup request frame.

18. The method for sensing measurement setup according to claim 16, wherein the second identification information is determined based on a transmitter address (TA) information in the SBP request frame.

19. The method for sensing measurement setup according to claim 15, further comprising:
receiving a user identification (USID) assigned by the AP to the SBP initiator, wherein the SBP initiator is the unassociated STA of the AP, and the SBP initiator participates in the sensing measurement.

20.-22. (canceled)

23. An electronic device, comprising a memory, a processor,
and a computer program stored in the memory and executable on the processor, wherein when the processor executes the program, the method according to claim 1.

24. (canceled)
